(19) United States
(12) Patent Application Publication
(10) Pub. No.: US 2006/0020504 A1
(43) Pub. Date: Jan. 26, 2006

(54) System and method for bill of materials grading

(75) Inventors: Siva R. Jasthi, White Bear Lake, MN (US); Venkata N. Marrapu, Blaine, MN (US)

Correspondence Address: DOCKET CLERK, PO BOX 800889, DALLAS, TX, 75380, US

(73) Assignee: UGS Corp., Plano, TX (US)

(21) Appl. No.: 10/898,713

(22) Filed: Jul. 23, 2004

(51) Int. Cl. G06Q 99/00

(52) U.S. Cl. 705/11; 705/1; 705/10

(57) ABSTRACT

A system and method for evaluating a product Bill Of Materials (BOM) against a set of measurable criteria. A Bill Of Materials (BOM) is a hierarchical representation of the product in terms of its constituent parts. The parts can be components or sub-assemblies or commercially available parts. Each “Node” in a BOM hierarchy has certain properties, and each node may also have relationships with other entities.

### TECHNICAL FIELD OF THE INVENTION

The present invention is directed, in general, to systems and methods for evaluating the quality of product structures.

### BACKGROUND OF THE INVENTION

Currently, the evaluation of the properties, interrelations, and availability of items in a bill of materials (BOM) against a property or a relationship is highly subjective to a given industry. For example, a medical industry may be more stringent in enforcing the constraints. Even within a given industry, different departments may evaluate the BOM in different ways. For example, a designer focuses on the existence of the parts while a purchaser focuses on the suppliers and distributors.

Since the BOM evaluation, as currently used, is so subjective, it is difficult to draw comparisons between different industries or even between different areas of the same industry.

There is, therefore, a need in the art for a system and method for objective bill-of-materials grading.

### SUMMARY OF THE INVENTION

A preferred embodiment includes a system and method for evaluating a product Bill Of Materials (BOM) against a set of measurable criteria. A Bill Of Materials (BOM) is a hierarchical representation of the product in terms of its constituent parts. The parts can be components or sub-assemblies or commercially available parts. Each “Node” in a BOM hierarchy has certain properties, and each node may also have relationships with other entities.

The foregoing has outlined rather broadly the features and technical advantages of the present invention so that those skilled in the art may better understand the detailed description of the invention that follows. Additional features and advantages of the invention will be described hereinafter that form the subject of the claims of the invention. Those skilled in the art will appreciate that they may readily use the conception and the specific embodiment disclosed as a basis for modifying or designing other structures for carrying out the same purposes of the present invention. Those skilled in the art will also realize that such equivalent constructions do not depart from the spirit and scope of the invention in its broadest form.

Before undertaking the DETAILED DESCRIPTION OF THE INVENTION below, it may be advantageous to set forth definitions of certain words or phrases used throughout this patent document: the terms “include” and “comprise,” as well as derivatives thereof, mean inclusion without limitation; the term “or” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, whether such a device is implemented in hardware, firmware, software or some combination of at least two of the same. It should be noted that the functionality associated with any particular controller may be centralized or distributed, whether locally or remotely. Definitions for certain words and phrases are provided throughout this patent document, and those of ordinary skill in the art will understand that such definitions apply in many, if not most, instances to prior as well as future uses of such defined words and phrases.

### BRIEF DESCRIPTION OF THE DRAWINGS

For a more complete understanding of the present invention, and the advantages thereof, reference is now made to the following descriptions taken in conjunction with the accompanying drawings, wherein like numbers designate like objects, and in which:

FIG. 1 depicts a block diagram of a data processing system in which an embodiment of the present invention can be implemented;

FIG. 2 depicts a simple example of a “Computer BOM,” in accordance with an embodiment of the present invention;

FIG. 3 illustrates some exemplary Properties and Relationships, in accordance with an embodiment of the present invention;

FIG. 4 depicts a schematic Diagram of a BOM Grading Process in accordance with a preferred embodiment;

FIG. 5 depicts an example of a “BOM Grading Report,” in accordance with an embodiment of the present invention; and

FIG. 6 depicts a flowchart of a process in accordance with a preferred embodiment.

### DETAILED DESCRIPTION OF THE INVENTION

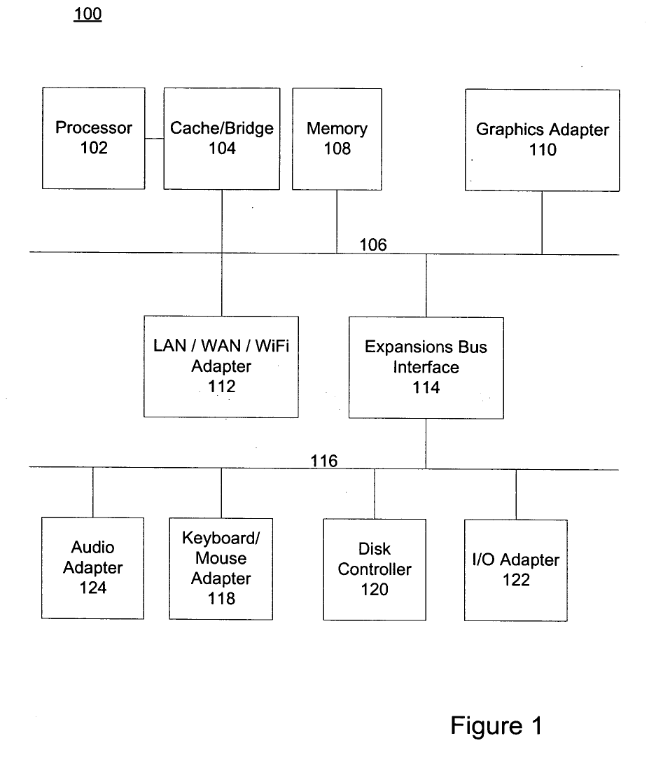

FIGS. 1 through 6, discussed below, and the various embodiments used to describe the principles of the present invention in this patent document are by way of illustration only and should not be construed in any way to limit the scope of the invention. Those skilled in the art will understand that the principles of the present invention may be implemented in any suitably arranged device. The numerous innovative teachings of the present application will be described with particular reference to the presently preferred embodiment.

FIG. 1 depicts a block diagram of a data processing system in which a preferred embodiment can be implemented. The data processing system depicted includes a processor 102 connected to a level two cache/bridge 104, which is connected in turn to a local system bus 106. Local system bus 106 may be, for example, a peripheral component interconnect (PCI) architecture bus. Also connected to local system bus in the depicted example are a main memory 108 and a graphics adapter 110.

Other peripherals, such as local area network (LAN)/Wide Area Network/Wireless (e.g. WiFi) adapter 112, may also be connected to local system bus 106. Expansion bus interface 114 connects local system bus 106 to input/output (I/O) bus 116. I/O bus 116 is connected to keyboard/mouse adapter 118, disk controller 120, and I/O adapter 122.

Also connected to I/O bus 116 in the example shown is audio adapter 124, to which speakers (not shown) may be connected for playing sounds. Keyboard/mouse adapter 118 provides a connection for a pointing device (not shown), such as a mouse, trackball, trackpointer, etc.

Those of ordinary skill in the art will appreciate that the hardware depicted in FIG. 1 may vary for particular. For example, other peripheral devices, such as an optical disk drive and the like, also may be used in addition or in place of the hardware depicted. The depicted example is provided for the purpose of explanation only and is not meant to imply architectural limitations with respect to the present invention.

A data processing system in accordance with a preferred embodiment of the present invention includes an operating system employing a graphical user interface. The operating system permits multiple display windows to be presented in the graphical user interface simultaneously, with each display window providing an interface to a different application or to a different instance of the same application. A cursor in the graphical user interface may be manipulated by a user through the pointing device. The position of the cursor may be changed and/or an event, such as clicking a mouse button, generated to actuate a desired response.

One of various commercial operating systems, such as a version of Microsoft Windows™, a product of Microsoft Corporation located in Redmond, Wash. may be employed if suitably modified. The operating system is modified or created in accordance with the present invention as described.

A preferred embodiment includes a system and method for evaluating a product Bill Of Materials (BOM) against a set of measurable criteria.

A Bill Of Materials (BOM) is a hierarchical representation of the product in terms of its constituent parts. The parts can be components or sub-assemblies or commercially available parts (COTS—Commercial Off The Shelf Parts).

Each “Node” in a BOM hierarchy has certain properties; one example of a “Property” is Part A used in the main assembly is “Approved” by the design team. A node may also have relationships with other entities; one example of a “Relationship” is that Part B used in the main assembly “Is Supplied By” 3 suppliers of which 1 supplier is a “Preferred” supplier.

“BOM Grading,” as used herein, is defined as the evaluation of a BOM Nodes as well as the entire BOM to know the quality of BOM. Based on the “Properties” and “Relationships” of the BOM Nodes, a “BOM Grading Processor” evaluates the BOM and presents the results to the user.

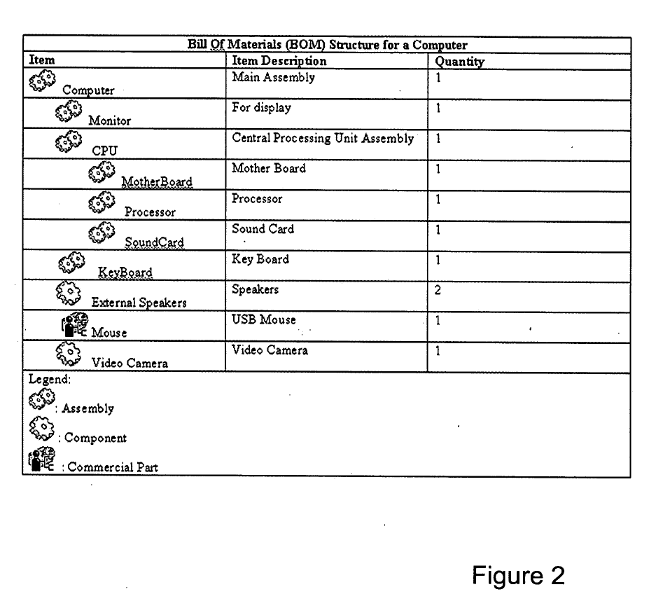

FIG. 2 depicts a simple example of a “Computer BOM,” to illustrate the “BOM Grading” process discussed below. This figure shows a list of items that form a computer system with icons indicating whether each item is an assembly, a component, or a commercial part. Preferably, a description of each item and the quantity of each item used in the top-assembly (for example, a computer has 1 monitor) are also included.

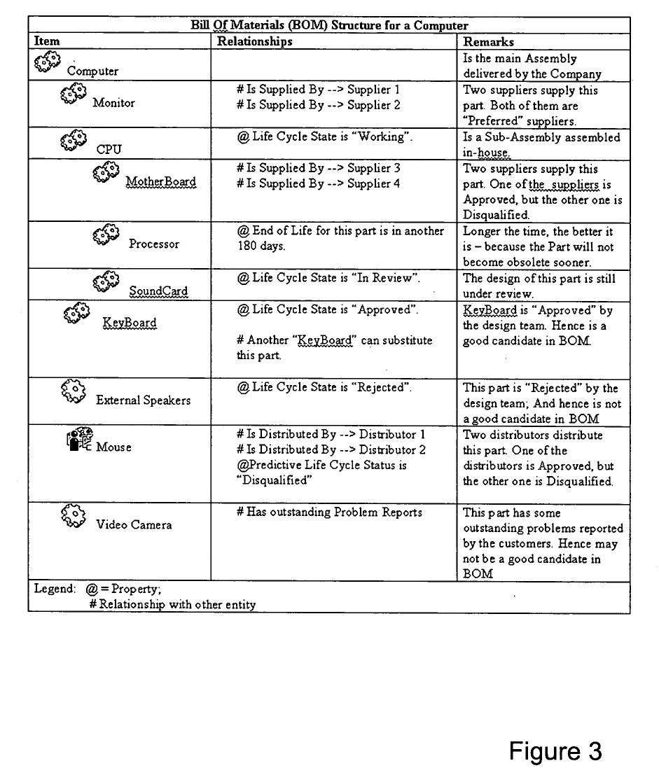

While the above figure outlines the basic structure of a BOM, each Node in the BOM has certain “Properties” and “Relationships” with other entities. FIG. 3 illustrates some exemplary Properties and Relationships.

The Bill Of Materials (BOM) Structure for a Computer, shown in exemplary FIG. 3, includes a list of items that form a computer system with icons indicating whether each item is an assembly, a component, or a commercial part. Also included, for each item, is a notation of Relationships particular to that item, along with remarks to describe, explain, or clarify the Relationships.

These BOMs evolve through different steps in the product development life cycle. For example, while developing new products, designers make use of many existing parts and also COTS (Commercial Off The Shelf) products. Also, procurement makes decisions on whether to make or buy a component.

At each of these stages, the users want to know the quality of the BOM based on a set of constraints. The disclosed BOM grading system evaluates the given BOM and gives the feedback to the user about the quality of BOM.

Several examples how a BOM Node can be evaluated are given below. This process of evaluating a given BOM based on “a Criteria” is called the BOM Grading.

Life Cycle State: (Property) For example, if “Part A” is used in an Assembly, but if the “Part A” is still under review process, it may not be a good choice for inclusion in the BOM. However, if “Part B” has undergone the review process and has already been “released”, then “Part B” is a good choice for inclusion in the context of Life Cycle State.

EOL Date: (Property) EOL Date (End of Life) Date represents the date at which the part becomes obsolete (i.e it may no longer be used or manufactured or supplied). Having components' in the BOM which has a farther EOLDate is good because the BOM will not become obsolete sooner.

Supplier Status: (Relationship) “Component E” is supplied by two Suppliers, but none of the Suppliers are “Preferred” by the company. However, “Component F” is supplied by three Suppliers and 2 of them are “Preferred” by the company. Hence, “Component F” is a better candidate for inclusion in the BOM.

Distributor Status: (Relationship) One or more distributors distribute a commercial part (COTS) that can be used in a BOM. Selecting a Commercial Part that is distributed by more number of “preferred” distributors is a good choice.

Outstanding Problem Reports: (Relationship) Assume that Component I and Component J are interchangeable. If Component I has fewer outstanding problems reported by the customers, it is a good choice for inclusion in BOM when compared to Component J.

As seen from the above examples, the evaluation of a BOM Node against a property or a relationship is highly subjective to a given industry; for example, a medical industry may be more stringent in enforcing the constraints. Even within a given industry, different departments may evaluate the BOM in different ways. For example, a designer focuses on the existence of the parts while a purchaser focuses on the suppliers and distributors.

The preferred embodiments provide a BOM Grading Application that can be configured and customized with regard to grading factors, grading constraints, and presentation. Grading factors address what can be evaluated, grading constraints address how these are evaluated, and presentation addresses how the evaluation results are presented to the user.

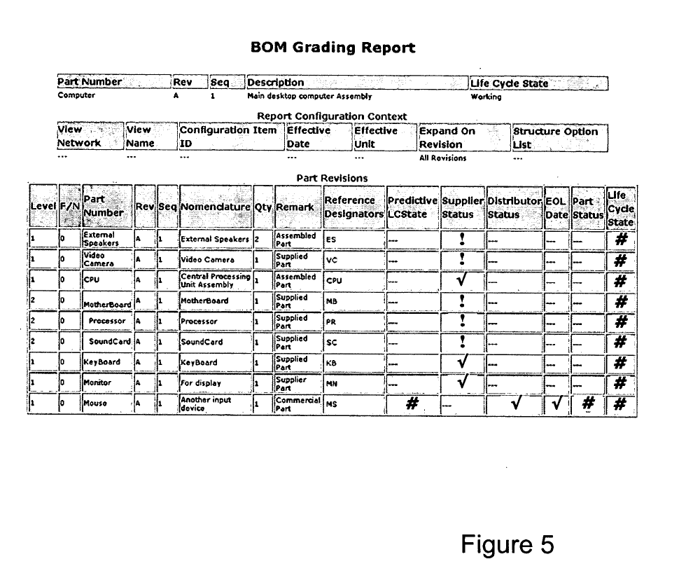

The preferred embodiments offer an elegant solution, as illustrated in the examples shown in FIGS. 2 and 3, to the BOM Grading problem via a specification of BOM Grading Process in XML that includes Schema, Factors, Constraints, and Presentation details. A preferred system includes a runtime evaluation of the grading process against a given BOM, and presentation of the BOM Grading results as a report to the end-user to give visual feedback, as illustrated in FIG. 5, below.

A preferred embodiment includes the ability to configure and customize the BOM Grading Process. Preferably, users can configure the *XML to meet the following goals:
Add (delete or modify) a Grading Schema
Add (delete or modify) grading factors to a given grading schema
Add (delete or modify) a class to which the grading factor can be applied
Add (delete or modify) a Constraint to the existing grading factor and a class
Add (delete or modify) a Presentation to the existing grading factor and a class

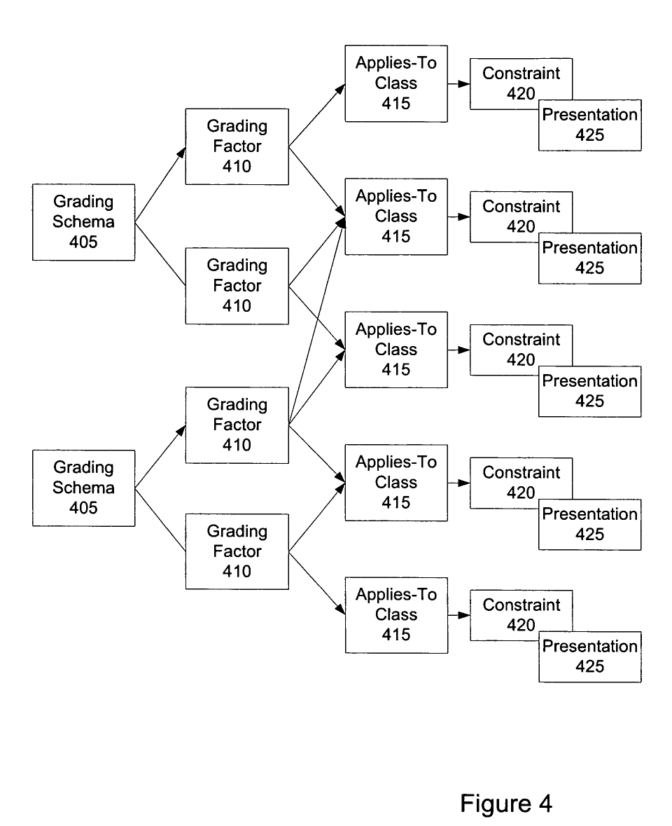

FIG. 4 depicts a schematic Diagram of a BOM Grading Process in accordance with a preferred embodiment.

According to a preferred embodiment, a Grading Schema 405 is comprised of 1 or more Grading Factors 410. A Grading Factor 410 is applicable to 1 or more Classes 415 (or Types of Nodes in the BOM). For a given Grading Factor 410, each Class 415 will have a corresponding Grading Constraint 420 and Presentation Template 425.

Grading Schema 405 denotes the overall schema for evaluating a given BOM. It can be defined as a set of Grading Factors 410. The Grading Schema addresses the question “which grading scheme is being used?” There can be separate schema for different individual users or classes of users; e.g., designers, manufacturers, and procurement personnel.

The Grading Factor 410 addresses the question “what is being evaluated?” For example, the Grading Factor can include evaluating a BOM Node based on “Supplier Status” or evaluating a BOM Node based on “End of Life Status.”

The Applies-to Class 415 addresses the question “is the given Grading Factor applicable to this BOM Node?” For example, Assembly, Component, Commercial Part, Composition are some types of Node that can participate in a BOM.

The Constraint 420 addresses the question “how is the BOM Node being evaluated?” For example, consider a “Part” Node in a BOM against the “Supplier Status” factor. One company may choose to give it a “green” status if there are at least five suppliers. Another company may choose that threshold to be 10 suppliers.

Presentation 425 addresses the question of “How is visual feedback provided to the user?” Once the grading is done for a “BOM Node” against a “Grading Factor,” the results can be displayed to the users. For example, “green” can mean “good” and “red” can mean “there is some problem.”

FIG. 5 depicts an example of a “BOM Grading Report” in accordance with a preferred embodiment. Here, a sample output report is shown, illustrating a BOM Grading presentation. Here, for purposes of clarity in a black-and-white figure, a checkmark indicates “good”, while an exclamation point indicates a problem, and a pound sign indicates a potential problem. As this figure is exemplary only, addition description of this figure is not essential to understanding the invention.

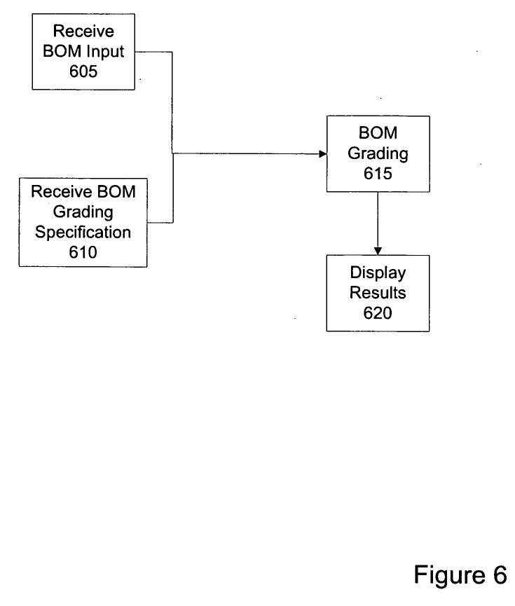

FIG. 6 depicts a flowchart of a process in accordance with a preferred embodiment. First, a data processing system will load or receive a BOM listing (step 605), the listing including a plurality of items.

The system will also load or receive a specification of a BOM grading process (step 610). As used herein “receiving” and object by the system is intended to also encompass loading the object from storage or memory. In a preferred embodiment, the specification includes Schema, Factors, Constraints, and Presentation definitions corresponding to some or all of the items in the BOM list.

Next, the system will receive an evaluation of each item on the list according to the corresponding factors and constraints in a BOM grading process (step 615).

Finally, the system will display the results of the BOM evaluation (step 620).

Those skilled in the art will recognize that, for simplicity and clarity, the full structure and operation of all data processing systems suitable for use with the present invention is not being depicted or described herein. Instead, only so much of a data processing system as is unique to the present invention or necessary for an understanding of the present invention is depicted and described. The remainder of the construction and operation of data processing system 100 may conform to any of the various current implementations and practices known in the art.

It is important to note that while the present invention has been described in the context of a fully functional system, those skilled in the art will appreciate that at least portions of the mechanism of the present invention are capable of being distributed in the form of a instructions contained within a machine usable medium in any of a variety of forms, and that the present invention applies equally regardless of the particular type of instruction or signal bearing medium utilized to actually carry out the distribution. Examples of machine usable mediums include: nonvolatile, hard-coded type mediums such as read only memories (ROMs) or erasable, electrically programmable read only memories (EEPROMs), user-recordable type mediums such as floppy disks, hard disk drives and compact disk read only memories (CD-ROMs) or digital versatile disks (DVDs), and transmission type mediums such as digital and analog communication links.

Although an exemplary embodiment of the present invention has been described in detail, those skilled in the art will understand that various changes, substitutions, variations, and improvements of the invention disclosed herein may be made without departing from the spirit and scope of the invention in its broadest form.

None of the description in the present application should be read as implying that any particular element, step, or function is an essential element which must be included in the claim scope: THE SCOPE OF. PATENTED SUBJECT MATTER IS DEFINED ONLY BY THE ALLOWED CLAIMS. Moreover, none of these claims are intended to invoke paragraph six of 35 USC §112 unless the exact words “means for” are followed by a participle.

What is claimed is:

1. A method for evaluating a bill of materials, comprising:
receiving a bill-of-materials listing including a plurality of items;
receiving a bill-of-materials grading specification;
evaluating each item according to the bill-of-materials grading specification; and
displaying results corresponding to the evaluation.

2. The method of claim 1, wherein the grading specification includes a grading schema.

3. The method of claim 1, wherein the grading specification includes grading factors.

4. The method of claim 1, wherein the grading specification includes grading constraints.

5. The method of claim 1, wherein the grading specification includes a grading presentation definition.

6. The method of claim 1, wherein the evaluation is performed by comparing the properties of each item against the grading specification.

7. The method of claim 1, wherein the bill of materials listing includes relationships between items.

8. A data processing system having at least a processor and accessible memory, comprising:
means for receiving a bill-of-materials listing including a plurality of items;
means for receiving a bill-of-materials grading specification;
means for evaluating each item according to the bill-of-materials grading specification; and
means for displaying results corresponding to the evaluation.

9. The data processing system of claim 8, wherein the grading specification includes a grading schema.

10. The data processing system of claim 8, wherein the grading specification includes grading factors.

11. The data processing system of claim 8, wherein the grading specification includes grading constraints.

12. The data processing system of claim 8, wherein the grading specification includes a grading presentation definition.

13. The data processing system of claim 8, wherein the evaluation is performed by comparing the properties of each item against the grading specification.

14. The data processing system of claim 8, wherein the bill of materials listing includes relationships between items.

15. A computer program product tangibly embodied in a machine-readable medium, comprising:
instructions for receiving a bill-of-materials listing including a plurality of items;
instructions for receiving a bill-of-materials grading specification;
instructions for evaluating each item according to the bill-of-materials grading specification; and
instructions for displaying results corresponding to the evaluation.

16. The computer program product of claim 15, wherein the grading specification includes a grading schema.

17. The computer program product of claim 15, wherein the grading specification includes grading factors.

18. The computer program product of claim 15, wherein the grading specification includes grading constraints.

19. The computer program product of claim 15, wherein the grading specification includes a grading presentation definition.

20. The computer program product of claim 15, wherein the evaluation is performed by comparing the properties of each item against the grading specification.

21. The computer program product of claim 15, wherein the bill of materials listing includes relationships between items.
